(19) United States
(12) Patent Application Publication
(10) Pub. No.: US 2015/0366190 A1
(43) Pub. Date: Dec. 24, 2015

(54) Sustained Release Methods to Defeat Plant Pests

(71) Applicant: BioGuard Technologies, Inc., Kennewick, WA (US)

(72) Inventors: Edward S. Lipinsky, Fairview, NC (US); Dominic A. Cataldo, Kennewick, WA (US); Peter Van Voris, Daniel Island, SC (US)

(73) Assignee: BioGuard Technologies, Inc., Kennewick, WA (US)

(21) Appl. No.: 14/687,949

(22) Filed: Apr. 16, 2015

Related U.S. Application Data
(60) Provisional application No. 62/014,152, filed on Jun. 19, 2014.

(51) Int. Cl. A01N 25/30; A01N 37/34; A01N 37/08; A01N 43/653; A01N 43/28

(52) U.S. Cl. CPC A01N 25/30; A01N 43/653; A01N 43/28; A01N 37/08; A01N 37/34

(57) ABSTRACT

A dilute concentrate for treating vegetation for suppressing fungi thereon, formed from a concentrate having components added in the following sequence fungicide, EtOH, and surfactant, at about 1:3:1 weight percent, respectively, and forming supramolecular assemblies comprising surfactant/fungicide/EtOH, surfactant/fungicide, and free non-associated fungicide; and a latex/water solution, wherein the supramolecular assemblies in the dilute concentrate now include latex/fungicide/surfactant, latex/fungicide, and free fungicide. Upon drying of a latex film from the dilute concentrate supramolecular assemblies, the composition of the assemblies regulates the release of fungicide from the dried latex film by the formation of active pools with varying water solubility, wherein the surfactant forms supramolecule assemblies with the fungicide via a non-covalent mechanism to produce (i) a composite surfactant/fungicide combination, a fraction of which assembles with the polymerizing latex via a non-covalent mechanism to form additional supramolecular assemblies and (ii) a fungicide/latex combination that is formed by a non-covalent mechanism.

### CROSS-REFERENCE TO RELATED APPLICATIONS

This application claims benefit of U.S. provisional application No. 62/014,152, filed on Jun. 19, 2014.

### STATEMENT REGARDING FEDERALLY SPONSORED RESEARCH

Not applicable.

### SCOPE OF DISCLOSURE

This disclosure uses advanced methods to interrupt the life cycle of Coffee Rust and other plant rust diseases. Rusts are plant diseases caused by pathogenic fungi (order Pucciniales). Phytophthoro spp., Pythium spp. (cocoa pod disease) are representative of an estimated 168 rust genera and approximately 7,000 species that are typical and induce rot diseases in high rainfall and moisture coffee crop growing areas. In addition to Coffee Rust, Wheat Rust, Maize Rust, Soybean Rust, Grain Sorghum Rust, Oat Rust, Peanut Rust, Barley Rust, Millet Rust, Cotton Rust, Citrus Tree Rust, Apple Tree Rust, Pine Tree Rust, Poplar Tree Rust, Turf Grass Rust, Sugarcane Rust, and Sweet Sorghum Rust, for example, are included.

Coffee Rust was chosen for experimental and discussion purposes because of coffee's economic importance (US $22 billion in 2012) and its stringent health requirements. Coffee Rust is similar to the numerous other rusts; therefor, the disclosed method can be used in many situations. Rust usually affects healthy and vigorously growing plants, resulting in reduced plant vigor and subsequently, fruit and seed yield. Entry of the spores is primarily through the stomata of the leaves. See the life cycle illustration by Vickie Brewster; Arneson, P. A. 2000. Coffee Rust. The Plant Health Instructor, DOI: 0.1094/PHI-I-2000-0718-02.

### BACKGROUND

There is a need for a sustained-release delivery system for crop pesticides, particularly in high rainfall areas, where costly and repeated fungicide applications are required to cope with seasonal disease outbreaks resulting from extended and frequent rainfall events. Coffee Rust has impacted many Indonesian, Latin American, and African countries very hard, reducing harvest yields significantly. The fungi can induce leaves to drop and fruit to rot on the branches. The farmers, growers, and coffee cooperatives have been combatting this disease by applying pesticide as many as 4 or 5 times during the rainy season, particularly in South and Central America. However, this disease management approach method is labor intensive, costly, and ecologically unsuitable.

Several scientific teams have been studying the “life-cycle” of coffee rusts, which has not been closed and the transport and infectious mechanisms are not fully understood. There is hope that full understanding will help the farmers, cooperatives, and growers to defeat the fungi either by disrupting its “life-cycle,” transport, and/or finding a bio-control agent that is ecologically sound; but, at the present time, the farmers are hoping for better more cost effective methods of chemical control.

The wheat rust lifecycle has been closed with the barberry plant host providing the closure. The newest wheat rust crisis comes from its rapid virulent races makes possible teliospores that inhabit wheat stalks during the cold winter. The use of electrostatics, as disclosed herein, could prevent teliospores and uridinospores in the under part of wheat from participating in the lifecycle. For many crops, including coffee, systemic fungicides are employed; unfortunately, these have a slight but significant water solubility and, thus, are subject to removal by repeated rainfalls, as in the case with many coffee varieties. What is needed is better coverage with longer retention of the active (the fungicide or biologic) extending the persistence of the active on the plant surfaces. This all will be an intermediate solution until life-cycle disruption and/or an effective bio-control agent can be found. Horticultural breeding of more resistant varietal may also only be an intermediate solution, because the sporulation process is designed to find and exploit new varietals by making certain that the colony has substantial genetic diversity to be adaptive to its host's defenses. Louis Pasteur said, “Success favors the prepared mind,” which adapts herein as, “success favors those who are genetically prepared.”

This disclosure proposes several embodiments plus a combination of standard literature/patent disclosures, involving a balanced use of latex, EtOH, and surfactants to speed up or moderate (with highly water soluble actives) uptake of actives, while limiting wash-off. Thus, the combination greatly extends functional longevity of a single application of active, while eliminating/reducing the need for repetitive applications of systemic pesticides

### BRIEF SUMMARY

Coffee growers need a method that places pesticide on both the top and bottom of the coffee leaves to inhibit the germination of fungal spores. With systemic fungicides, conventional or aerial spraying would do well with the spraying on the top leaf surfaces; this is not totally effective for coffee rust, which enters the plant through stomata on the bottom of the leaf. As shown in FIG. 1, most of the attack comes from under the leaf—through the stomata. The use of systemic fungicides overcomes the shortfalls of typical backpack and aerial spray approaches.

Research reveals evidence that fine particles of hydrated/precipitated pesticide will stick to both the top and bottom of the leaf when the particles are applied and mixed within a latex base for retention. The latex films and particles also stick better to leaves and other surfaces, and promote systemic transport of actives between spray applications. It has also known that the use of surfactants in commercial formulation (without latex), increase active solubility and uptake by the plant. The problems encountered in high rainfall areas are that the commercial formulations containing surfactants tend to wash off easily with rainfalls due to increased solubility of the actives, and the efficacy of latex has been limited by the severe entrainment of active, and requirements for releasing agents.

This disclosure makes use of concepts that have been demonstrated by supramolecular chemistry, including host-guest chemistry and molecular self-assembly. Supramolecular chemistry is the domain of chemistry beyond that of molecules and focuses on chemical systems. While traditional chemistry focuses on the covalent bond, supramolecular chemistry makes use of the weaker and reversible noncovalent interactions between molecules. These forces include, inter alia, hydrogen bonding, hydrophobic forces, van der Waals forces, pi-pi interactions, electrostatic effects and magnetic effects. Thus, disclosed is method for treating vegetation or plant growth for suppressing fungi thereon using composition for treating vegetation for suppressing fungi thereon, comprising a dilute concentrate formed from a concentrate having components added in the following sequence fungicide, ethanol (EtOH), and surfactant, at about 1:3:1 weight or mass ratio, respectively, and forming supramolecular assemblies comprising surfactant/fungicide/EtOH, surfactant/fungicide, and free non-associated fungicide; wherein the supramolecular assemblies form by non-covalent mechanisms being one or more of π-π interaction, hydrogen bonding, Van der Waals forces, dipole-dipole, cation-π and anion-π interaction, polar-π, hydrophobic effect, electrostatic effect, or magnetic effect; and a latex/water solution, wherein the supramolecular assemblies in the dilute concentrate now comprise latex/fungicide/surfactant, latex/fungicide, and free fungicide;

Upon drying of a latex film from the dilute concentrate supramolecular assemblies, the composition of the assemblies regulates the release of fungicide from the dried latex film by the formation of active pools with varying water solubility, wherein the surfactant forms supramolecule assemblies with the fungicide via a non-covalent mechanism to produce (i) a composite surfactant/fungicide combination, a fraction of which assembles with the polymerizing latex via a non-covalent mechanism to form additional supramolecular assemblies and (ii) a fungicide/latex combination that is formed by a non-covalent mechanism.

The surfactant is one or more of polyethylene glycol, polypropylene glycol, a polylactic acid, or a polyglycolic acid, and is admixed with one or more of ethanol, methanol, or isopropanol. The fungicide is an active ingredient being one or more of cyproconazole, propiconazole, chlorothalnnil, tefluthrin, pyrethroids, fenpyoximate, abamectin, spiroxamine, or epoxiconazole. The latex is a latex primer present in the dilute concentrate at not substantially above about 1 wt % (dry wt basis) and assists in forming the supramolecular assembly via non-covalent mechanisms being one or more of π-π interaction, hydrogen bonding, Van der Waals forces, dipole-dipole, cation-π and anion-π interaction, polar-π, hydrophobic effect, electrostatic effect, or magnetic effect.

### BRIEF DESCRIPTION OF THE DRAWINGS

For a fuller understanding of the nature and advantages of the present method and process, reference should be had to the following detailed description taken in connection with the accompanying drawings, in which:

FIGS. 1A and 1B graphically display ethanol solvent (EtOH) (FIG. 1A) and aqueous (FIG. 1B) extractive of fungicide cyproconazole with and without latex, as reported in Experiment 1;

FIGS. 2A and 2B graphically display ethanol solvent (FIG. 2A) and aqueous (FIG. 2A) extraction of cyproconazole active in order to mimic heavy rainfall weathering and release of active, as reported in Experiment 1;

FIG. 3 graphically displays relative solvent (methanol, MeOH) extractability of cyproconazole active from the surface coating without latex, as reported in Experiment 1;

FIG. 4 graphically displays relative MeOH solubility with the same formulation reported in FIG. 3, but with 2% added latex, as reported in Experiment 1;

FIG. 5 graphically compares MeOH solvent extraction results for 9 different surfactants in a 2% latex/cyproconazole coating formulation, as reported in Experiment 1;

FIG. 6 graphically displays MeOH solvent extraction results for the best-reported surfactants in FIG. 5 for both chlorothalonil and spiroxamine fungicidal actives, as reported in Experiment 1;

FIG. 7 graphically displays aqueous leaching profiles for latex-based formulations containing only cyproconazole active in 1×EtOH solvent and 4×EtOH solvent, as reported in Experiment 1;

FIG. 8 graphically displays aqueous leaching rates for 5 different surfactants that exhibited good latex retention in cyproconazole active latex formulations, as reported in Experiment 1;

FIG. 9 graphically displays aqueous leaching profiles for latex formulations containing spiroxamine active with and without 3 different surfactants and no surfactant, as reported in Experiment 1;

FIG. 10 graphically displays aqueous leaching profiles for latex formulations containing chlorothalonil active with and without 3 different surfactants and no surfactant, as reported in Experiment 1;

FIG. 11 graphically displays aqueous leaching profiles formulations containing chlorothalonil active with and without surfactants, as reported in Experiment 1;

FIG. 12 graphically displays aqueous leaching profiles formulations containing cyproconazole active with and without surfactants, as reported in Experiment 1;

FIG. 13 graphically displays aqueous leaching profiles formulations containing spiroxamine active with and without surfactants, as reported in Experiment 1; and

FIG. 14 graphically displays the formation of supramolecule assemblies based on chemical environment.

The drawings will be described in greater detail below.

### DETAILED DESCRIPTION

There is a need for a sustained-release delivery system for crop pesticides, particularly in high rainfall areas, where costly and repeated applications are required to cope with seasonal disease outbreaks resulting from extended and frequent rainfall events.

Latex as a sticking agent and carrier for pesticides has been evaluated for decades, but has failed to be used commercially. In general, the use of latex based sprayable foliar coatings suffered from the need for excessive concentration of latex solids that on drying irreversibly bind active without inhibiting plant pathogens, poor retention of films on plant leaves, and an inability to regulate release within the concentration range for both efficacy and upper plant toxicity levels.

In general, the latex paint is a polymeric coating that can be used to retard the release of active agents through entrainment within the polymer lattice. On drying, the latex polymer coalesces to form a water-permeable coating (curing). Thus, the polymer chains form a homogeneous film. However, this normally requires a mass of solids to form the normal latex film, in excess of approximately 10%-20%, resulting in a dense polymer lattice that entrains actives extremely well resulting in very low active release and, thus, is not very useful for control of agricultural diseases and infestations. We have been exploring the use of very dilute latex formulations (1% to 5% solids in water), to provide a system that will release an active for periods of 2 to 6 months, under extreme precipitation conditions (rainy seasons).

In response to a Roya outbreak (fungal induced foliar rust), and in cooperation with a coffee co-op in Central America, a series of inexpensive formulations was designed to treat and control the foliar rust disease during the 5-7 month rainy season. In response to the need for a 6-month control formulation with a single application, a series of formulations were evaluated for total active retention within dried latex films, and subsequent aqueous release over time.

The question was how to adjust and control the release of active from aqueous latex solutions. To address this need, the influence of EtOH on latex polymerization and entrainment of active and the influence of low concentrations of surfactants to behave as releasing agents (RAFT'S) was considered. Surfactants are an important component of commercial pesticide formulations, and provide for a variety of essential functions. These include, inter alia, suspension and/or solubilization of actives, cuticular penetration/plant absorption of systemic actives, and in some cases modification of the pH and charge environment for specific actives. The concentration of the individual components within foliar surfactant formulations varies from product to product, and generally is employed at concentrations of 0.2% to 2% (v/v) on dilution of the commercial concentrate for spray application.

Commercial pesticide formulation incorporating surfactants and other performance enhancers improve suspension/solubility of actives in the applications solution, but are lost from foliar surfaces by rainfall, and impaction of rain drops on leaves, thus limiting longevity, currently 2 to 6 weeks.

The goal was to determine whether the actives could be chemically caged/altered in the concentrate, prior to dilution, and influence the release and longevity to greater than 5 months from a single spray application, while maintaining an effective level of active release and plant uptake; yet, not be at a high enough concentration to carryover into the bean itself.

For example, a formulation generally consists of a pesticide that is known to kill or repel the fungus of interest, liquid suspended latex (usually water, but sometimes an oil), and surfactants, was tested in the coffee fields and in laboratory studies. The formulation begins with a concentrate where the technical grade solid or liquid pesticide is dissolved/suspended in EtOH (ethanol), followed by addition of a surfactant. This concentrate is subsequently dilutes in an aqueous solution containing 2 to 5% latex primer. These items are mixed to make fine particles that are suspended in the liquid, and entrained by and within the forming latex micelles. All of the free water and EtOH evaporates during this application process.

The pesticide formulation actually applied to foliage is composed of components A and B, and on mixing form formulation C, with its component supramolecular assemblies (SMA's). Component A is prepared by adding active to solvent (EtOH), followed by the surfactant; this sequence of addition improves the formation of the SMA's. Short chain alcohols, such as methanol and isopropanol, work as well as ethanol. The SMA's formed in the preparation of the stock solution (prior to aqueous dilution) consist of 2- and subsequently 3-component SMA's. On dilution of component A with aqueous Component B (latex/water) 1-, 2- and 3-component SMA's form, with the 3-component SMA dominating with increasing latex concentration. On drying of the film, there is a loss of water and free EtOH, resulting in a 2- and 3-component SMA, and likely the formation of submicron precipitated active when the actives have very low water solubility. Results indicate that the EtOH is still influencing release rate after drying and, thus, may remain as part of he SMA's. The formation of the various SMA's result from a combination of formulation factors, namely the assembly intensity of the SMA of the specific actives, surfactants, and latex. In the dry film, there are at least three active pools that influence release rates and performance longevity. These include the fast releasing 2-SMA component (active/surfactant), the slow releasing 3-SMA component (latex/active/surfactant), and for highly water insoluble actives, the presence of water in excess in formulation C will by simple mass balance yields submicron precipitates, which will be very slow to release. This is illustrated in FIG. 14.

### Formulation Ingredients

### 1. Pesticides:

| | | | |
|---|---|---|---|
| Cyproconazole* | Propiconazole | Prothioconazole | Tebuconazole |
| Fenpyoximate | Chlorothalonil | Flutolanil | Sproxamine |
| Thiophanate-Methyl | Azoxystrobin | Pyraclostrobin | Propamocarb |
| Mefanoxam | Fosetyl-Al | Mancozeb | Abamectin |
| Pyrethroids | Cypermethrin | Cyphenothrin | Deltamethrin |
| Lambda- | Metofluthrin | Permethrin | Tetramethrin |
| Cyhalothrin | | | |
| Tefluthrin | Bifenthrin | Endosulfan | Beauveria |
| | | | Bassiana** |

*technical grade, is used to replace the commercial formulation. Atemi 10 SL, is a commercial concentrate containing 10% cyproconazole before dilution.
**biopesticide spores

The formulation requires slightly hydrophilic polymeric matrices for sustained release, and water solubility in the presence of surfactant to aid transfer of pesticide to the plant interior and fungi. Applicable actives include fungicides and insecticides.

### 2. Solvents for Actives

Coffee rust prevents high yields of the coffee plants. We have found that use of special solvents for cyproconazole enhance yields substantially. Cyproconazole can be dissolved in ethanol in the disclosed formulation prior to spraying. Ethanol does well in the disclosed formulations. It also is accepted for food use.

Acetic acid also is a candidate that is food grade. Cyproconazole is also dissolvable in acetic acid. The azole functional group in cyproconazole reacts to acidity. Ethyl acetate combines with ethanol with acetic acid and can used as a neutral solvent, for example. Ethyl acetate has been used to decaffeinate coffee beans. It can be used as a source of a mild acid.

Lactic acid can be added to water and act as a strong solvent with a strong acid. It can promote reactions. It is food grade in the US and in Europe. Ethyl lactate is made from ethanol and lactic acid. It is a strong solvent. Lactic acid is about 10 times as strong as acetic acid. The azole functional group in cyproconazole reacts to acidity. That is why ethyl lactate is preferred in some applications.

1,2-propane diol is a relatively inexpensive solvent that is known to dissolve the disclosed actives that compete with ethyl alcohol, etc. 1,3-propane diol is a good solvent, but it is expensive. Glycerine is a good solvent, but is quite viscous and may cause spraying problems. 1,3-dioxolane is good solvent. 1-4 dioxane also is a good solvent, but it has toxicity and environmental drawbacks.

Thus, ethyl alcohol, ethyl acetate, and 1,2-propanediol appear to be the best solvents for these formulations.

### 3. Latexes—Primers

Several embodiments are proposed, plus a combination of a balanced use of latex and surfactants to control release of fungicide actives, while limiting wash-off. Thus, the combination greatly extends functional longevity of a single application of active, while eliminating/reducing the need for repetitive applications of systemic pesticides.

Latex base formulations used in commercial paints are varied formulations of polymeric materials and other compounds. The prior art shows that bioactives can be entrained within polymerizing latex micelles (an aggregate of surfactant molecules dispersed in a liquid colloid). These generally have very low release rates to the surface, or poor vapor release of actives to air and, thus, are not very effective in performing specific pest control functions. Prior art also teaches the use of leaving agents to alter the polymerized structure of latex and, thus, increase release, but these have not resolved the bio-efficacy (release) of latex borne bioactives particularly related to inhibited wash-off and adequate release for bioefficacy.

It is commonplace to add fungicides/anti-mold actives to latex paints—but this is not a present goal, since the mold organisms are physically eroding into the latex film and access the bioactive. Limiting wash-off is desired in order to extend the functional longevity of a single application; rather than requiring multiple applications for plant protection, while at the same improving plant absorption.

Latex is known to immobilize pesticides with plant leaf application, but its usefulness has been limited by high retention of the active and, thus, in plants limit foliar absorption of systemic actives.

The disclosure targets the need for a foliar formulation containing a fungicide active, that will prevent wash-off in heavy rainfall (rainy season), yet allow for the controlled mobility of the active into the leaves; thus, improving its systemic movement and control of disease.

The present method for altering the release of bioactives from polymerized water-based latex formulations incorporates several stages of release/foliar/root absorption control. The functional components of this system include:
a. Preparation of a stock solution (formulation for aqueous dilution) in which the active is contained in a solubilizing liquid (EtOH) that renders the active soluble and a wetting agent/carrier (surfactant). This functions to limit precipitation in storage and form a series of protective supramolecular assemblies (SMA's).
b. Dispersion of the stock formulation into aqueous latex solutions results in the formation of a series of active pools. With moderately low and highly water soluble actives, these include the formation of a series SMA's, and a limited submicron dispersion of active. At this point SMA's are formed between the active/surfactant SMA's and the latex monomers/polymers. It most effective in reducing active solubility and release from the latex film that a 1 to 1 weight percent of active to surfactant be maintained in the EtOH stock solution. With water insoluble actives, SMA's are formed as above with latex and surfactants, but a higher fraction of active persists as entrained submicron particles.
c. The EtOH contained within the formulation, on addition to the aqueous latex, forces a rapid localized encapsulation/latex polymer micelles of the active/surfactant microspheres. On drying of the latex/formulation composite, the active SMA's are dispersed and entrained within the latex film.
d. The carrier/surfactant used to promote encapsulation and/or mobility of the active depends on the relative behavior of a particular class of actives with respect to its vapor pressure and water solubility. Polyethylene glycol oligomers are indicated in the SMA formation process.

These four items lead to the following outcomes:
The release of relatively water insoluble to high solubility, low to high vapor pressure actives within and to the film surface based on latex by adjusting the actives chemical environment and extent of entrainment, association, assembly, and/or encapsulation.
The mobility/entrainment of non-water soluble and water soluble actives within the polymer and SMA formation within the film can be regulated by adjusting active SMA's and limiting entrainment within the latex film.
Limiting the precipitation of water insoluble actives within the latex polymer/micelles through the use of surfactants/carriers.
Promoting the uptake/foliar absorption of systemic actives using compatible surfactants/SMA's.

The latex exterior primer/sealer seems to function best. Other interior latex combinations evaluated have poor adhesion and release active very rapidly or are irreversible entrained within the latex. The latex exterior primer/sealer of choice is a Glidden® product reported to have the following general composition: ethanol, 2-(2-butoxyethoxy)-CAS 112-34-5, 1-5%; limestone, -65-3, 5-10%; titanium oxide, CAS 13463-67-7, 10-20%; quartz, CAS 14808-60-7, 5-10%; 2-propenoic acid, 2-methyl-, methyl ester, polymer with ethylbenzene and 2-ethylhexyl 2-propenoate, CAS 25750-06,-5 1-5%; water, CAS 7732-18-5, 30-40%; oxirane, methyl-, polymer with oxirane, CAS 9003-11-6, 1-5%; and styrene acrylic copolymer, SUP.CONF, 10-20.

The characteristics of typical water-soluble latex coatings and bioactives, that affect the above release/plant absorption parameters, include:
The normal tendency of latex polymers to have a degree of water of hydration, which while allowing water soluble actives to migrate and release, actually inhibits the movement of low water solubility bioactives by forcing precipitation/hydration.
Limiting the precipitation of water insoluble bioactives by use of complex formation with wetting agents/surfactants, and allowing for a controllable formation of SMA's and movement and release of bioactives from latex polymers.
Use of surfactants to accelerate the uptake of actives into the leaves, and allow for systemic mobility and protection against a disease.
Chemical and biological insecticides can be entrained within dilute latex polymers without surfactants, to limit wash-off, and allow insect pests to be controlled while grazing on and ingesting leaves and/or fruit/seeds. Access to actives is by ingestion by the pest, with minimal plant uptake and accumulation of active.

### 4. Fungicide Actives:

Fungicidal actives evaluated include, inter alia, cyproconazole, chlorothalonil, and spiroxamine, water, and solvent solubility and are considered representative of the listed candidate actives. Further fungicides include commercial fungicide formulations, such as, for example, ATEMI (Syngenta), OPERA (BASF), ESFERA (Bayer), OPUS (BASF), HELIX (Fedecoop), SOPRANO (Adama), and CIPROSOL.

Insecticides employed to control plant pests, are generally systemic and supplied by foliar treatment, and thus subject to similar wash-off processes limiting efficacy and longevity. The latex method described can be used similarly with chemical insecticides (i.e., bifenthrin, trifluthrin, endosulfan) to augment the longevity and delivery of application employing latex based SMA's. The method can be adjusted to provide either systemic/absorption of active, or fixed latex/active films without surfactant to allow the film efficacy to be dependent on pest insect grazing on plant tissues (leaves, berries, etc) and ingestion of active, without systemic plant uptake.

Bioinsecticidal spores (e.g., Beauveria Bassianna, control of coffee borer) are of increasing interest as a non-chemical control option. Biocontrol has been limited by the cost and need for high concentration of spores to control pests over a lengthy period on time due to erosion and wash-off. Use of thin film latex, with good foliar/tissue retention can be used to extend the treatment time efficacy of biocontrol agents with bio-stabilizers as pest control resulting from ingestion while boring into tissues.

Experiment evidence concludes that Glidden gripper primer functions well in the field. Other latexes considered include RHOPLEX™ B-15J and RHOPLEX™ CL for latex use. RHOPLEX™ B-15J is a cross-linkable acrylic binder with excellent mechanical stability and runnability. This acrylic binder is recommended where strength, durability, and flexibility are required this latex will have a degree of self thickening when the pH is increased. RHOPLEX™ CL is an acrylic emulsion for use in water-based clear finishes and has outstanding clarity.

Latex base dilution: Testing used a latex base primer that was 50% solids. The base was diluted to either 1% to 5% solids (2% to 10% latex base), in a final volume adjusted to 100 mL. The latex dilution was kept stirred using a magnetic stirrer, at a speed sufficient to form a conical vortex for introduction of other ingredients. It was determined that a 2% to 5% (1% to 2.5% latex solids) diluted base had good adhesion and carrying capacity for the active.

In addition, other latexes that may be preferred in certain circumstances include, inter alia:
a. AC-339 Acrylic Emulsion Polymer is a very hydrophobic.
b. B15J self thickening, strength, flexibility and durability
c. CL RHOPLEX™ CL Acrylic emulsions shed water and coalescent rapidly.
d. CS CS-4000 acrylic polymer emulsion is a water-resistant binder.
e. EP-6060 is a water-based acrylic polymer providing good wet and dry clarity of films.
f. R RHOPLEX™ R Aqueous acrylic polymer release coatings.
   Several of them feature clarity.

### 5. Surfactants

Commercial surfactant formulations can include cationic, anionic, and/or nonionic compounds, including, for example, salts of fatty acids, alkyl sulfates, etc. The formulations and products available are extensive. We employed/evaluated the following: LUROL PP912T (emulsifier), ethyl alcohol (EtOH, which acts as a solvent and also as a surfactant), L1700 (Loveland nonionic surfactant based on soybean oil), Dow NP-7 (Alkylaryl polyether alcohols that are very flexible nonionics), Surf-90 (DuPont fluorine based that is expensive), AGRHO FKC1500, Aduvants Unlimited AU-369, Au-391A, AU398, AU361 surfactants, and petroleum based ORTHO Volck oil.

### 6. Polymer

In addition to latexes that are polymers, other polymers also can be included in the formulations. Nano-particles and micro-particles can be trapped or embedded within the polymer. Copolymers of polyvinyl alcohol or polyethylene glycol with acrylamides are the most widely used. The three-dimensional structure of these hydrogels and metal-organic-frameworks allows sustained release.

Nano- and microcapsules are comprised of an outer shell that encapsulates the active agent. The active is encapsulated inside the particle and it is released by the degradation of the polymer coating. Several polymers have been exploited for this kind of formulation, such as, for example, polyesters, polyanhydrides, and polyamides.

Micelles are composed of individual linear polymers that contain a hydrophobic and a hydrophilic segment, which has the capacity to form micellar structures in aqueous media. The hydrophobic core of polymeric micelles facilitates the incorporation of hydrophobic active ingredients either through covalent or non-covalent interactions.

Metal-organic-frameworks (MOF) are large porous materials that can be used to harbor latexes. The pores of the two substances can be of different sizes so that controlled and sustained release can be attained. The sorption capacity of MOF-500, for example, is four times greater than that of the molecular compound IRMOP-51.

Dendrimeric structures allows the encapsulation of actives with hydrophobic properties in its interior cavities while functional groups found on their surface can attach hydrophilic materials by covalent bonds, electrostatic interactions and hydrogen bonds.

### Application of Polymers to the Problem of Plant Rust

Given this background, this disclosure makes use of several promising polymer solutions to fungal coffee rust problem:
1. Polymers with good foliar adhesion are needed to keep the active ingredient from eroding or washing off of the leaves that are being protected. Polyvinyl alcohol, polyvinyl acetate, and copolymers of polyvinyl alcohol or polyethylene glycol with acrylamides can be used for this purpose.
2. Sustained/Controlled release polymers include dimer acids reacted with polyols. Also, polyesters, polyanhydrides, and polyamides are sustained/controlled release polymers.
3. The exact polymerization conditions, in particular type, metering and amount of the emulsifier, are preferably selected in such a manner that the latex of the acrylic ester, which is at least partially crosslinked has a particle size that suits the spraying requirements.
4. Reactive silanes can be sprayed onto the leaf surface to form a very thin surface that allows carbon dioxide and air to enter but may keep fungi out. Leaf moisture is a reactant.

The following examples show how the disclosure has been practiced, but should not be considered as limiting.

### Experiment 1

### Experimental Formulation Testing

Latex, GLIDDEN® Gripper latex base/primer (GL3210-1200, PPG Architectural Finishes, Inc., Pittsburgh, Pa.) was selected because of its high solids content and sticking agents that gave the solution and dried film excellent foliar retention at latex solution concentrations of 2 to 10 vol-% (1 to 5% solids). The selected latex base/primer worked much better than non-primers, and had exceptionally good foliar retention. Ethanol was used to solubilize all actives prior to dilution of the stock into latex/water.

Performance evaluations were undertaken using three common fungicides with a range of water solubilities and solvent solubilities. These included cyproconazole having a water solubility of 90 mg/L and a solvent solubility of 250 g/L (EtOH), chlorothalonil having a water solubility of 0.81 mg/L and solvent solubility of 10 g/L, and spiroxamine having a water solubility of 400 mg/L and solvent solubility of 200 g/L. All actives were loaded at 600 μg/ml, unless otherwise noted. Films contained 20 to 60 μg of active. Amount of active in extracts was determined by HPLC.

Two experimental protocols were used to evaluate aqueous release and the extent of active retention. The first protocol was a rapid solvent extraction screen that involved dipping the coated specimens sequentially into vials containing 35 ml water for 1, 1, 5, and 10 minutes, then 50% MeOH for 10 minutes, and 100% MeOH for 24 hours. This protocol provided a rapid comparison of water soluble and entrained, but releasable, active fractions. The second protocol was to assess release rates based on simulated precipitation/rainfall conditions. This protocol involved maintaining test samples in successive 35 ml volumes of water for 24-hour periods for up to 288 days, providing a cumulative daily release rate from dried films. This water extraction period was followed by a single extraction in 100% MeOH for 24 and 48 hrs to determine residual/entrained or solvent removable active. The aqueous leach procedure is considered extreme in simulating intermittent daily rainfalls of varying intensity, but does provide the rates of release for comparative purposes.

Active Release from Ethanol/Latex Formulations without Surfactants

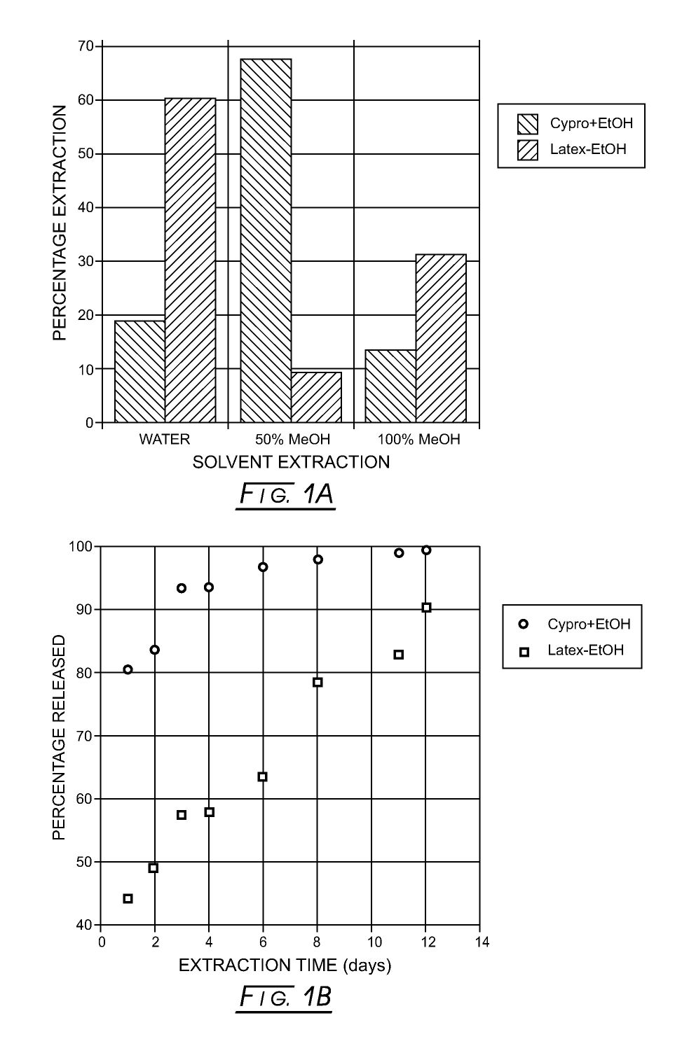

The influence of formulation factors on cyproconazole release and entrainment from aqueous solutions containing 0.2% EtOH without latex (FIG. 1A) was compared to the subsequent EtOH studies with latex. Solvent extractions showed the water extractable fraction, 50% MeOH fraction and 100% MeOH fraction, to contain 18.5, 68, and 13.5% of the active respectively, with a recovery of 96% of the supplied active. This would be expected to represent the relative solubility and release of active, and likely dependent on water solubility of the active.

To determine the influence of latex on cyproconazole release, cyproconazole was first dissolved in ethanol and added to 2% latex solutions to assess the effects on cyproconazole binding with latex using solvent extractions (FIG. 1A). Again, solvent extractions using water (17 minutes, 50% MeOH for 10 minutes and 100% MeOH for 24 hours was used to approximate the binding characteristics of the active. The presence of latex results in an apparent increase in the 100% MeOH fraction (32% versus 13%), suggesting some finding within the latex lattice, but again good overall recovery/extraction (99%).

To determine the simulated rainfall impacts of release and retention, water extractions were performed over 288 hours. Without latex, active is rapidly extracted (FIG. 1B). In the presence of latex, the active exhibits a slower release rate profile over the 288 hours, indicating retention of active by the latex lattice. Without latex, aqueous losses of supplied active was at 90% at 2.5 days, compared to latex/EtOH which took 12 days to attain 90% loss to water.

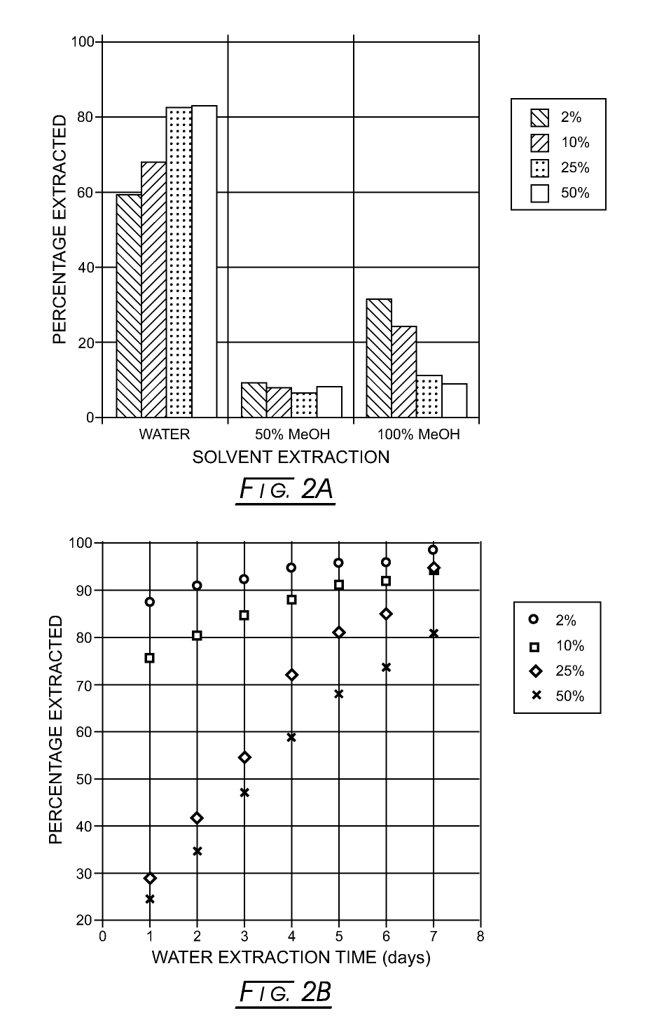

The overall influence of EtOH concentration in the formulation on the retention and release of active was evaluated using both solvent and water extractions. Samples containing cyproconazole were prepared with 600 μg active in 2%, 10%, 25%, and 50% solutions, and then added to the latex base having sufficient water to maintain the EtOH concentrations in the final formulation. Solvent extractions profiles showed an increasing release of active with increasing EtOH concentration in water, and a decreasing recovery in the 100% MeOH extraction (FIG. 2A). This result would indicate the EtOH is not playing a significant effect of latex polymerization nor active entrainment.

In contrast, the water extraction profiles used to mimic heavy rainfall weathering and release of active, exhibit a different behavior (FIG. 2B). There is a pronounced influence of EtOH concentration on release. At 2% and 10% EtOH, there is a major release of active, with a slow release over the 168 hours. At the 25% and 50% EtOH levels, release is dramatically reduced. Additionally, only 30% to 60% of active applied to the test surfaces is removed with the extended water leach series and subsequent 100% MeOH extraction, and this declines with increasing EtOH concentration. This would indicate that EtOH is influencing latex polymerization, active entrainment and/or the supra molecular association of the active with the latex polymer lattice on drying (water/solvent removal).

At 2%-10% EtOH in 2% latex solutions, a noticeable thickening occurs within 4-5 hours, and significant thickening occurs with 50% EtOH at 1 hour. While this polymerization effect may affect observed release profiles, it is also likely that the EtOH (stocks and latex dilutions) may affect the chemistry of the active and/or entrainment of the active within the polymer lattice based on EtOH concentration in the final diluted formulation.

### Influence of Releasing Agents in Regulating Latex Incorporated Active Release

In the past, releasing agents (RAFT's) have been used in attempts to release actives entrained within the latex polymers that form on drying. These were not appropriate for low concentration latex films, since release is already in most instances too high. Based on earlier non-crop work with latex, we found that a textile surfactant (GOULSTON® PP912T, Goulston Technologies, Inc., Monroe, La.) was effective in retarding the release of volatile pesticides from latex films. Thus, a series of commercial surfactants approved for crop use were evaluated (Table 1). Unfortunately, all available surfactants are proprietary formulations, and specific compositions are not available.

TABLE 1
List of Surfactants Evaluated

| | Non- | Anionic/ | | Cuticular | |
|---|---|---|---|---|---|
| Anionic | ionic | Cationic | Surfactant | Penetration | Comments |
| Loveland | Y | Y/— | Y | | |
| LI700 | | | | | |
| Powerline | Y | | Y | Y | wetter-will |
| Surf-90 | | | | | promote uptake |
| | | | | | somewhat |
| Rhoda | | | Y | | Similar to Surf- |
| Agro 1500 | | | | | 90 |
| Dow NP-7 | Y | Y/— | Y | | |
| Adjuvants | Y | —/Y | Y | Y | Designed for |
| Unlimited | | | | | Glyphosate |
| AU-391A | | | | | |
| AU-369 | Y | | Y | | Naturally |
| | | | | | derived sticker |
| AU-361 | Y | | Y | | Petrochemical |
| | | | | | derived sticker |
| AU-398 | Y | | Y | | Non- |
| | | | | | tallowamine |
| | | | | | version of |
| | | | | | 391A |
| Goulston | Y | | Y | | Textile |
| PP912T | | | | | conditioner |
| Ortho | Y | | Y | Y | Petroleum |
| Volck | | | | | product |

Surfactants are used with all pesticide formulations in agriculture to provide specific functional traits to the applied actives. These include one or more of the following: allow for solubilization/suspension of the active for spray application, addition of compounds to improve transfer of active through the leaf cuticle, and overall charge of these to improve application efficacy by adjusting the associated active/surfactant charge, and sticking agents. The above surfactants were selected based on prior results indicating that PP912T was beneficial to control the release of insecticides in thin film latex spray applications.

The composition and preparation of all test formulations is as follows:

### Stock A Concentrate

### Active/surfactant

| | |
|---|---|
| EtOH | 100 ml |
| Cyproconazole | 25 gm (95% purity, 23.7 gm) |
| Surfactant | 20 ml (10 ml contains 1.78 gm Cyproconazole, |
| | 1.43 gm Surf, 7.1 ml EtOH/ml) |

Mixing order: active dissolved in EtOH, then surfactant added and mixed to form a stable solution or suspension depending on surfactant.

The preparation of the diluted latex application mix is as follows:

### Application/Diluted Formulation

Latex 20 gm base (50% solids) in 987 ml water
Add with stirring, 3.4 ml of stock A (100 ml contains 60 mg Cyproconazole, 48 mg Surf, 240 mg EtOH; percent of components is 0.06%, 0.048%, and 0.24%, respectively)

The EtOH is used as a simple solvent to solubilize the low water solubility actives we used. The surfactants were used to provide non-covalent associations/coating of the active to retard mobility of the latex entrained active.

### Control Studies

This relative success of the extended performance longevity, and the over release of active necessitated an evaluation of the formulations to determine applicable variables controlling retention and release of active.

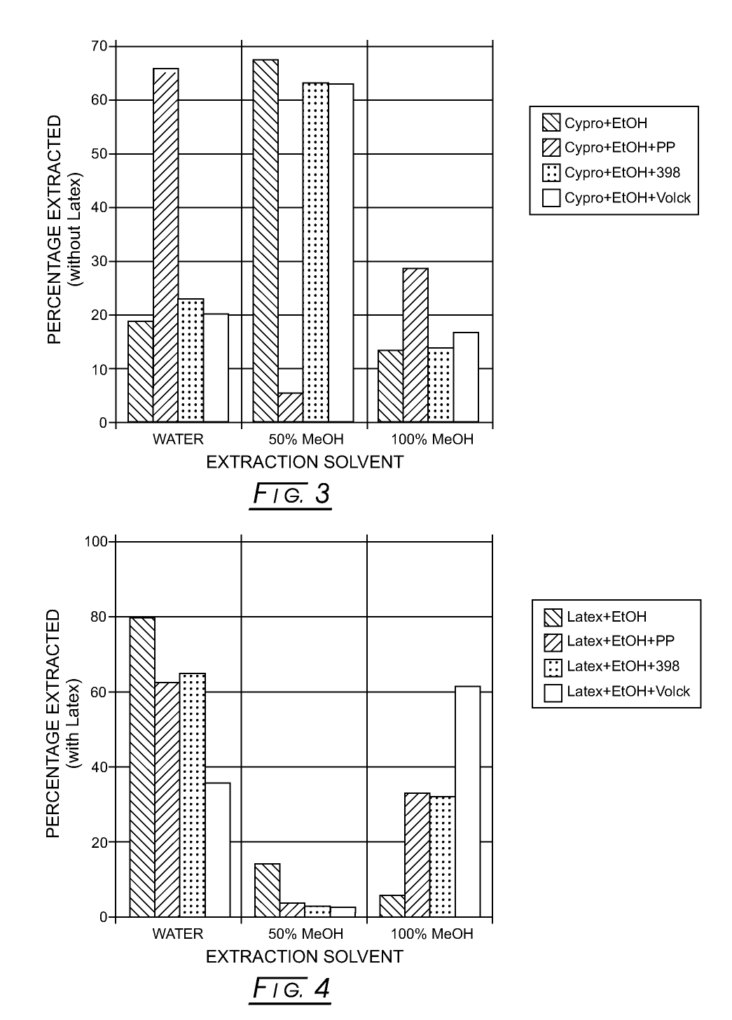

The first step was to determine the solvent extractability of the non-latex formulations. This was based on readily soluble (water, 17 minutes), easily soluble (50% MeOH, 10 minutes), and relatively non-water soluble (100% MeOH, 24 hr) fractions of the formulations (FIG. 3). The variables evaluated included: 1) the relative extractability of cyproconazole by dissolving the active in EtOH, and then adding to the water phase (no latex, with only EtOH and cyproconazole), this resulted in a rapid precipitation of active as a result of its low water solubility; and 2) dissolving the active in EtOH, adding each of the surfactants (PP912T, AU-398, and Volck oil) to the stock EtOH/cyproconazole solution, then and adding the mixture to the water phase, without latex.

Results of the solvent extraction showed mixed results. The addition and rapid dilution of the concentrated active stock on addition to water without latex, likely lead to a variable precipitation of the active, even with very dilute levels of surfactant (approx. 1 to 1 ratio in mass).

In FIG. 4, the same study was run, but with the aqueous phase containing 2% latex. In the presence of polymerized latex, the water and 50% MeOH fractions were reduced, and the 100% MeOH fraction increased or decreased with surfactant, indicating an entrainment of active within the latex lattice for all surfactants, but not the EtOH without surfactant.

A total of nine commercial surfactants (Table 1) were compared for relative entrainment of cyproconazole in latex, based on the percent of active contained in the 100% MeOH fraction (FIG. 5). These broke down, with respect to percent in 100% MeOH, into two groups, low (NP-7, SURF-90, L1700, and Agro 1500) and high entrainment (AU-398, AU-391A, AU-361 and AU-369).

The same solvent extraction protocol was used to evaluate 2 other fungicides (chlorothalonil and spiroxamine) with differing chemistries (water solubility and solvent solubility). These were evaluated using the same solvent extraction protocol. The three surfactants that worked best with cyproconazole were used for these actives.

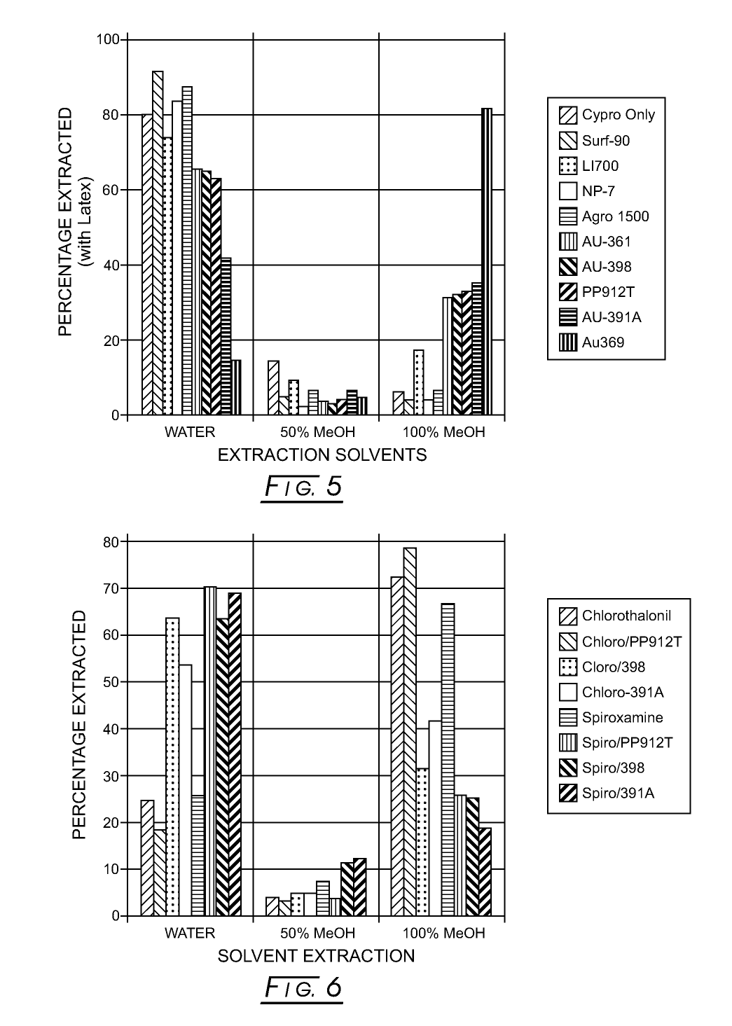

Each active stock was formulated with each of the three surfactants that worked well with cyproconazole: PP912T, AU-398 and AU-391A (FIG. 6). Chlorothalonil, with a relatively low water and solvent solubility, exhibited an increase in 100% MeOH retention in PP912T and AU-398, compared to no surfactant. Spiroxamine, with very high water solubility and solvent solubility, exhibited increased release to water in the presence of all three surfactants, compared to the no-surfactant control.

### Simulated Rainfall/Aqueous Leaching

The solvent extraction method used above represents a rapid screen for the comparative entrainment behavior of actives and surfactants in the formulated latex system. To address the problem of foliar retention and longevity of actives using a single field application is more a function of rainfall frequency and intensity. To better understand this process under laboratory conditions, we employed a continuous/sequential aqueous (pH 6.0-6.8) leaching process, with periodic sampling and replacement of the solution over periods up to 288 hrs. This is a rather harsh leaching process, but is more representative than the water/MeOH solvent extraction procedure used for screening.

In the simulated rainfall study, we compared the aqueous extraction patterns for cyproconazole at 0.06% with 0.24% EtOH (1×) added to latex (with no surfactant), cyproconazole with 0.06% EtOH and 0.05% PP912T added to latex, and cyproconazole with 1% EtOH (4×) and 0.05% PP912T added to latex. This combination was designed to determine formulation variables including surfactant and increased EtOH.

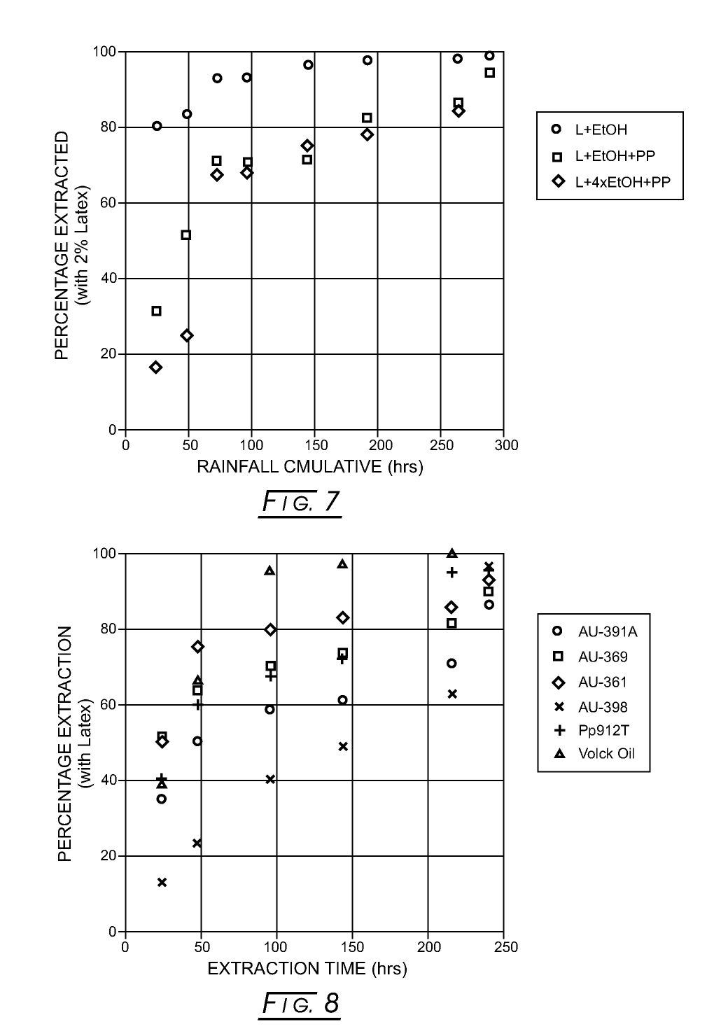

Latex formulations with cyproconazole in 1×EtOH exhibited a rapid loss of active at 24 hrs, and slowly depleted (FIG. 7). The formulation with the surfactant (PP912T) exhibited a slower initial release to 70 days, then slowly depleted to 90% of supplied active at 288 days, indicating entrainment in the latex lattice. Excess EtOH (4×) reduced the rate of extraction to 70 days compared with surfactant with 1×EtOH, again indicating a possible secondary influence of EtOH on latex polymerization.

FIG. 8 shows the aqueous leaching rates for the surfactants exhibiting the best latex retention (AU-398, AU-391A, AU-361, AU-369 and Volck oil). In field trials, PP912T performed very well for at least 6 months in controlling rust re-infestation, but was deemed over releasing as a result of early observations of leaf curl in treated leaves only. In comparing the various surfactants, it is clear that all, except for Volck oil, provided a slow release of cyproconazole to water over the 288-day extraction period. The results show the presence of a readily available pool that has a higher rate of aqueous extraction per day, than the entrained pool that exhibits a slower and longer release profile.

Volck oil releases too fast, based of the coffee reference formulation containing PP912T as does AU-361 and AU-369. The surfactants AU-391A and AU-398 have rates lower than PP912A, and may be better suited to replace PP912T with respect to toxicity and efficacy.

Aqueous extraction of formulations containing chlorothalonil and spiroxamine with latex without surfactant and with PP912T, AU-398 and AU-391A were compared to evaluate long term extraction profiles and residual active after 144 hrs of extraction, sampled at 24 hr intervals.

In FIG. 6, using the solvent extraction regime, the behavior of the low water soluble spiroxamine exhibited lower extraction rates in water without surfactant, than with the surfactants AU-391A and AU-398. A similar pattern was noted for chlorothalonil, which has much lower water solubility than either spiroxamine or cyproconazole. This suggests that without surfactant chlorothalonil is being sequestered within the latex matrix.

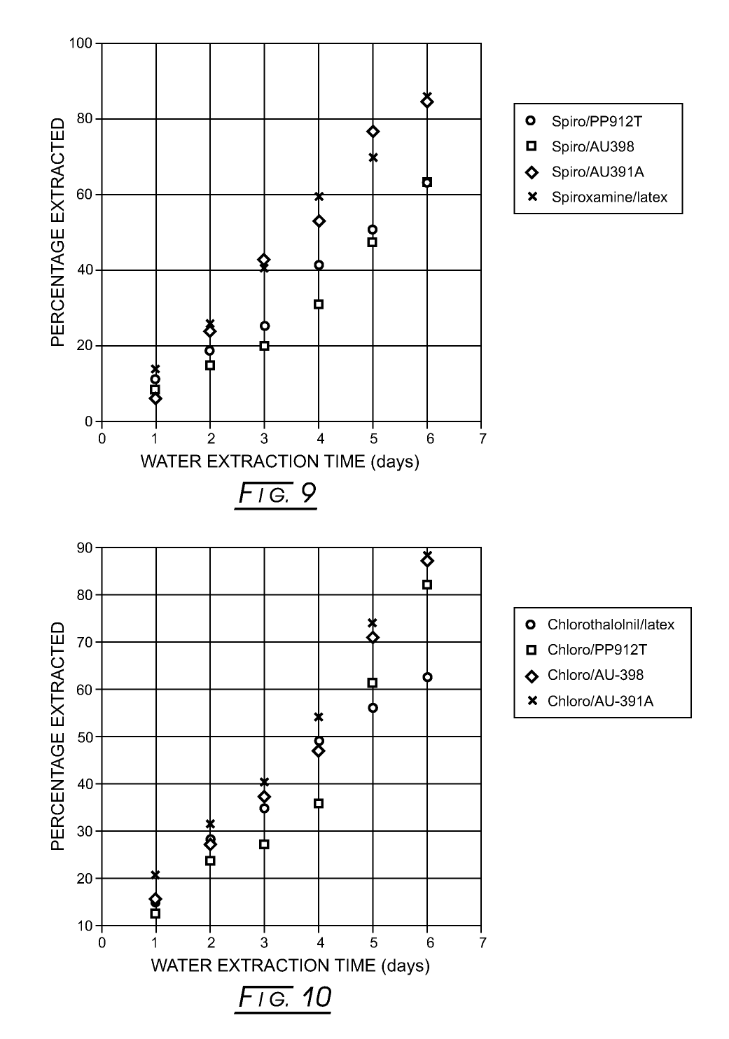

The rates of spiroxamine release to water from latex films, with and without surfactants are shown in FIG. 9. Spiroxamine has the highest water solubility (400 mg/L) of the three active classes evaluated (90 and 0.8 mg/L, cyproconazole and chlorothalonil, respectively), yet the presence of 2 of the three surfactants (PP912T and AU-398) suppress rather than accelerating release to the water phase over time. Latex alone and latex plus AU-391A released 85% of the recoverable active over the 144 hr extraction period, compared to 50% for PP912T and AU-398, with the balance being removed with 100% MeOH. What is notable is that while cyroconozole, with its very low water solubility was easily extracted with MeOH solutions, Spiroxamine required a 48 hr, rather than 24 hr extraction time to remove the majority of entrained active. These results support the role the formation of SMA's with latex.

The behavior of chlorothalonil (FIG. 10) in latex, with and without surfactant differed from cyproconazole and spiroxamine, in that the lowest release rate of 63% at 6 days was obtained with latex alone. With surfactants release rates increased to 80-88% of active. The surfactants AU-398 and AU-391A increased release of the very low water solubility active, while only PP9127 depressed early release out to 4 days. MeOH extraction was effective over 24 hrs, unlike with spiroxamine. This again supports the role of multiple SMA pools.

Results obtained for the latex and surfactant studies indicated that a number of probable factors are at play in controlling active release rate. These include EtOH, latex matrices, and the surfactant, and their role in acting as hosts in the formation of supramolecular assemblies controlling active release and extending protective longevity. As regards to maintaining release in the presence of surfactants, and role with regards to active release with latex.

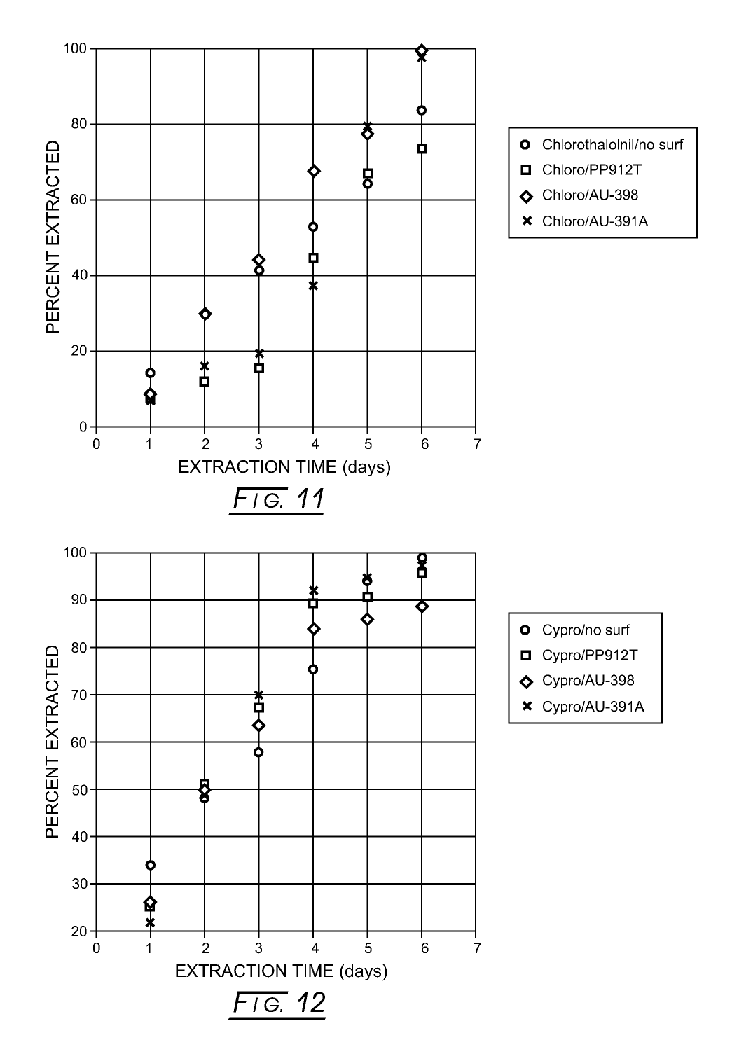

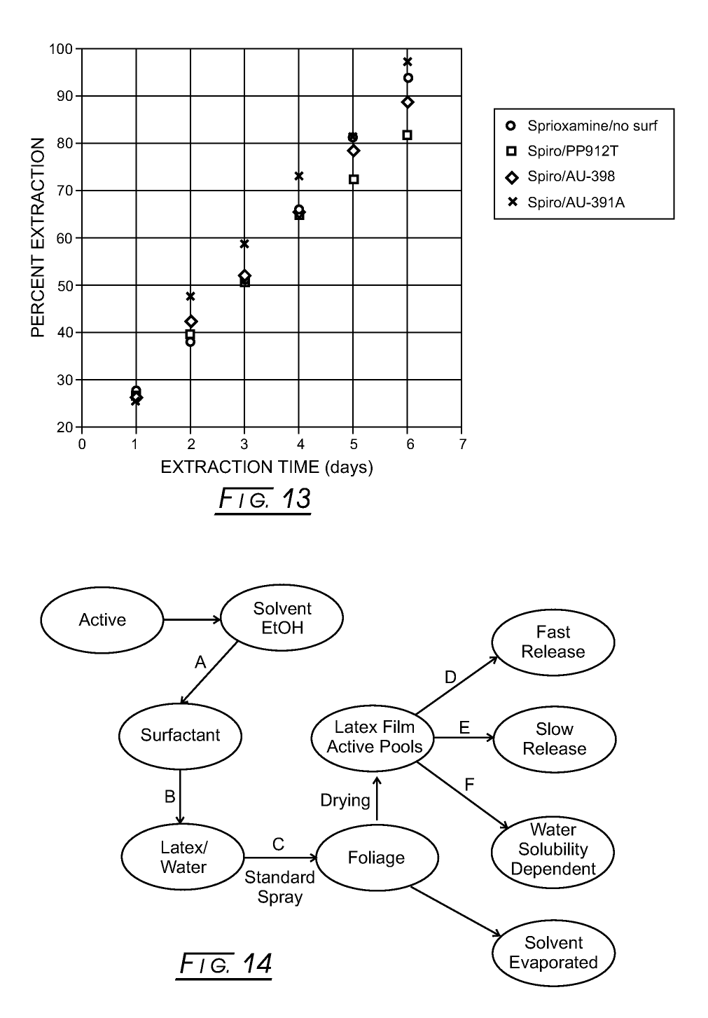

To resolve the issue of the role of latex in participating in the formation of SMA's, a study was conducted with the three actives, with and without surfactant in the formulation, and extraction profiles compared for the presence of the 3 most effective surfactants (FIGS. 11, 12, and 13). These actives represent three different chemical classes with a wide range in water solubility (0.08, 90, and 400 mg/L).

Chlorothalonil with a low water solubility of 0.8 mg/L, exhibited a varied release behavior with surfactants (FIG. 11). Chlorothalonil without surfactant exhibits a linear release rate in time, but 16% of active remained after 6 days of extraction. The surfactants AU-398 and AU-391A exhibited different release kinetics compared with the no surfactant treatment. AU-398 and 391A exhibited a reduction in release rate over the initial 1 to 4 day aqueous leaching period, followed by an increase between 5 to 6 days. PP912T depressed the release rates compared to the no surfactant treatment over the entire 6 days. The behavior of AU-398 and AU-391A can be explained by increased solubility of the active, while the behavior of PP912T indicates that a molecular interaction is slowing release. Both AU-391A and PP912T, with their slower initial release, would indicate the presence of multiple SMA pools.

Spiroxamine, with its very high water solubility (400 mg/L) exhibits a slightly different behavior than observed with cyproconazole and chlorothalonil. The active in a formulation with latex and without surfactant exhibits a relatively linear release rate over the 6 days extraction period, with 94% being released. The surfactants PP912T and AU-398 depress the release profile substantially, while AU-391A increases the release rate based on the percent of active lost at 6 days. Again supporting a more important role of latex in participating in SMA formation, suppressing release, and a likely interaction of latex as a major host for the active/surfactant SMA's.

It is clear from the data that the surfactants tested have an impact on both the release rate and functional longevity of the active, as does the latex. While this is varied with individual surfactants and active class, the approximately equal masses of the active and surfactant in the stocks solutions before dilution, indicates that the mechanism of entrainment is likely related to the chemical interaction of the active and surfactant and the formation of SMA's, and the involvement of latex as a component of one of the SMA pools. It also is clear that the presence of surfactants has an effect on the SMA's that are formed and affects the solubility of the active containing SMA's; this includes increasing and decreasing solubilities/aqueous extractability. The EtOH likely affects the polymerization process by removing available water (likely localized) on addition of Stock solutions to the water latex solution. However, use of excess EtOH in the current application is not practical, since the applied solution would polymerize and thicken too fast and, thus, very possibly interfere with any spray application. However, the use of up to 25% EtOH can be used to improve SMA's when needing to regulate release of highly water soluble actives, since irreversible binding of active was not noted at EtOH concentrations of 50% (v/v)

### Surfactant Composition/Active Interaction

How to explain the behavior of the three actives evaluated. We know that cyproconazole has moderate water solubility (WS of 90 mg/L), chlorothalonil has a low WS (0.8 mg/L), and spiroxamine has a high WS (400 mg/L); they also represent different chemical classes, an azole, a chlorinated nitrile, and an amine, respectively. Table 2 tabulates the behavior of the three actives, and their relationship to surfactant content of PEG oligomers.

TABLE 2
Composition of Surfactants

| | |
|---|---|
| LCMS Relative | |
| Abundance | Latex Performance |

| Surfactant | PEGO | High RR | Low RR |
|---|---|---|---|
| Dow NP-7 | 0.2 | (No effect) | (No effect) |
| PP912T | 2.25 | Chl | Cyp, Chl, Spir |
| AU-391A | 5.0 | Chl | Cyp |
| AU-398 | 0.05 | Chl | Cyp, Spir |

PEGO—Polyethylene glycol oligomers
RR—relative release rate
Cyp—cyproconazole
Chl—chlorothalonil
Spri—spiroxamine

Chlorothalonil is very water insoluble. In the presence of a high concentration of PEG oligomers (PGO's) in the surfactant stocks (prior to dilution) and diluted into latex solutions, can be significantly increased with PP912T and AU-391A. Release is also increased by AU-398 (FIG. 10), and although having low PGO's, the formulation has high PEG related compound concentrations, and likely has a higher affinity for the active. Chlorothalonil benefits more from the interaction of the surfactant with the latex matrix than in water alone or with surfactant.

Cyproconoazole, with moderate water solubility, exhibits a wide range in release reduction with surfactants (FIG. 8). Release rates at 6 days range from 50% of supplied active for AU-398 to 60% for AU-391A to 73% for PP912T.

The spiroxamine, even with its high water solubility, has a substantial reduction in release rate for PP912T and AU-398, compared to latex alone. AU-391A has no effect on release, compared to latex alone.

Each of these observations strongly indicate a role for supramolecular chemistry (SMA's), including host-guest chemistry and molecular self-assembly. Latex and surfactant composition (PGO's and PGO-related compounds likely play significant roles. Supramolecular chemistry is the domain of chemistry beyond that of molecules and focuses on chemical systems. While traditional chemistry focuses on the covalent bond, supramolecular chemistry makes use of the weaker and reversible noncovalent interactions between molecules. These forces include, inter alia, hydrogen bonding, hydrophobic forces, van der Waals forces, pi-pi interactions, electrostatic effects and magnetic effects.

These observations indicate that dilute latex solutions can be used to reduce active release to water (moisture/rainfall events), and that the effect is not based on increased release by the surfactant, but an interaction of the surfactant with the surfactant and the polymerized latex matrices.

In summary, it is clear that the surfactant has an affinity for the actives and likely is forming non-ionic associations. Some surfactants are better than others, and this may be the reason for the behavior of different actives and different surfactants. This would be true of the solvent alone and solvent with surfactant. The solvent/EtOH evaporates on film drying leaving the active and surfactant and latex solids/matrix, resulting in a three-way association. This three-way association has 2 components, and fast releasing one, and a slow releasing one accounting for the extended release that we see. So, in the presence of moisture or rainfall, the fast releasing component which dissociated from the latex/active/surfactant complex, diffuses into the moisture component without precipitation due to the surfactant, and enters the plant (this is how the commercial formulations work). However, the strength of association of the active/surfactant/latex must be stronger than the latex/surfactant alone to account for the poorer performance of the Atemi-surfactant-active/latex versus our formulated latex/EtOH/active/surfactant. The other factor is the actual water solubility of the active. With high water solubility actives (spiroxamine) only the association of the active/surfactant with the latex matrix (higher) will affect and slow release. With very low solubility actives (chlorothalonil) the strength (lower) of the active/surfactant association with the latex governs (needs to be a lower strength association) release. With moderate solubility actives (cyproconazole) both the association strength of the active/surfactant with latex governs release. This would explain why the data indicated different surfactant affect release and longevity.

### Experiment 2

### Experimental Coffee Field Trials

### Field Trials in Costa Rica

Field trials were initiated in Costa Rica in May 2014, as a result of a significant fungal rust outbreak, threatening the coffee crop. Normally, commercial cyproconazole products last only 4-6 weeks due the high rainfall in the coffee regions, and, thus, require 3 to 5 reapplications. Our objective was to extend the protective period. Plots that were 10 meters by 10 meters with 6 meters between plots were established to compare a number of the disclosed latex formulations to the commercially available formulations containing cyproconazole or chemically related fungicides. All field plots were monitored monthly by a qualified agronomist for progress of the rust infestation, which included previous rust active and inactive damage/infection, and the level of new infestations. Three plots of the primary formulation employed for coffee, afforded protection for 6 weeks, and then failed based on new infection indicators and the formation of active plaques. Controls consisting of triplicate plots for “No Treatment (pH adjusted water alone) and Latex (Glidden primer sealer) alone with no active components also failed within 4-6 weeks and were then retreated to make certain they were not significant sources of infestation. A total of 9 plots were used to establish a baseline and statistically block for “no treatment”, “latex only” treatment, and the “primary formulation” treatment (RoyaGuard). The latex treatments that had active/surfactant combinations, including mixing the primary formulation into the latex, showed no active infections, and no new infections for a full 6 months.

The performance of our latex formulations was compared to a commercial cyproconazole formulation, and the same formulation in latex (all formulations at 0.015% active applied). Latex at 2% in the commercial formulation showed a significant benefit from latex and was effective for 5 months, while without latex failure occurred at 1.5 months. It should be noted that the commercial formulation does in fact contain surfactants that are not chemically defined. The comparable cyproconazole/PP912T/latex treatment lasted for at least 6 months, with no indication of active infection, or new infection.

While the results were better than expected, there was minor leaf curl observes in the highest concentration of active/surfactant latex treated plants, indicating an over release and absorption of active by the plant. The intermediate treatment level did not show the leaf curl, which is typically an indication of overtreatment of the active. The formulations are listed in Table 3, while a summary of the results is set forth in Table 4.

TABLE 3
Final 50 L Spray Dilution

| | Cyproconazole | EtOH | PP912T | | | % Cyproconazole in |
|---|---|---|---|---|---|---|
| Treatment | (g) | (ml) | Surfactant | | Latex (L) | Diluted Concentrate |
| Latex Only | 0 | 0 | 0 | | 1 | 0 |
| Atemi Alone | 4.5 | 0 | ~10 | g* | 0 | 0.01 |
| Atemi/Latex | 4.5 | 0 | ~10 | g* | 1 | 0.01 |
| **RoyaGuard 1x | 6 | 35 | 5 | ml | 1 | 0.012 |
| RoyaGuard 3X | 15 | 90 | 15 | ml | 1 | 0.030 |
| RoyaGuard 5X | 25 | 125 | 25 | ml | 1 | 0.050 |

*Unknown proprietary surfactant and composition.
**RoyaGuard is the disclosed composition being evaluated.

TABLE 4

| | Days Post Treatment (% Roya Present) | | | | | |
|---|---|---|---|---|---|---|
| Treatment | 0 | 35 | 60 | 100 | 155 | 180 |
| Control-No Treatment | 0 | Failed-Sprayed | Lots of Roya | Failed- | Lots of Roya- | Sprayed |
| | | | | Resprayed | Now Under | Again |
| | | | | | Control Via | |
| | | | | | Spray | |
| Latex only | 0 | Failed-Sprayed | Lots of Roya | Failed- | Lots of Roya- | Sprayed |
| | | | | Resprayed | Now Under | Again |
| | | | | | Control Via | |
| | | | | | Spray | |
| Atemi only | 0 | — | Hi Level Roya- | >5% Good | >20% Spray | Sprayed |
| | | | Needs Respraying | Condition | Again Soon | Again |
| | | | | After | | |
| | | | | Respraying | | |
| Atemi/Latex | 0 | — | Active Roya | <5% Great | <20% Not | Sprayed |
| | | | Damage, but | Condition | Good-Spray | Again |
| | | | Control | | Again | |
| RoyaGuard 1X | 0 | — | Very good Roya | <5% Great | <10% Good | <10% Good |
| | | | control | Condition | Condition | Condition |
| RoyaGuard 3X | 0 | — | Very good + Roya | <3% | <10% Good | <10% Good |
| | | | Control | Excellent | Condition | Condition |
| | | | | Condition | | |
| RoyaGuard 5X | 0 | — | Very good + Roya | <3% | <5% Great | <5% Great |
| | | | Control Leaf Curl | Excellent | Condition | Condition |
| | | | | Condition | | |

### Experiment 3

### Chemical Insecticidal applications

The use of the dilute latex/surfactant systems can be used for a wide variety of chemical insecticides, particularly when a vapor phase of active is preferred for contact kill and/or repellency. Additionally, this system without surfactant can be employed as a non-releasing system where the active is either entrained directly within the latex matrix and/or using a secondary supramolecular assembly (SMA) and/or using EtOH as the intermediate host for the molecular association with latex and active.

Tests were conducted with bifenthrin and tefluthrin. Bifenthrin has a water solubility of 0.001 mg/L, high solvent solubility, and a vapor pressure of 0.0178 mPa. Tefluthrin has a water solubility of 0.016 mg/L, high solvent solubility, and a vapor pressure of 0.84 mPa. These were selected for their low water solubility and thus inability to transfer to the edible portions of food crops.

Actives were dissolved in ethyl alcohol and/or isopropyl alcohol. Dilution of active to latex solution was set at 0.2% active (w/w). Test slides were dipped, and dried at 35° C. for 12 hrs, prior to evaluation. Loss from dried films was determined gravimetrically and weekly intervals to access vapor loss of active. After 4 weeks at 30° C., losses for both actives was less than 3±4%. This indicated the entrainment of the high vapor pressure actives within the latex, with minimal vapor loss. The low loss rates show that this approach can be used for latex films to protect crops or ornamentals from grazing insect pests.

This approach is applicable to a wide range of insecticides, and anti-browsing compounds, such as, for example, the bitter dentatonium benzoate.

### Experiment 4

### Biological Control Applications

Biological control options, particularly pathogenic fungal spores and bacteria, are adequate for low level infections in plants, but suffer from cost and environmental longevity limitations including: wash-off of the spores/bacteria, uv inactivation, and the inability to maintain a conducive environment/stabilizers on the foliar surface. Laboratory studies with water insoluble clay particles (2 to 37 micron mixtures) show that particles can be readily entrained in dilute latex films. This makes the thin latex films very suitable for improving the retention of biological control agents on plant surfaces with the non-releasing bio-pesticides being accessed in the normal grazing process for most insect pathogens.

Similarly, low-level biological pathogen infestations can be controlled using non-releasing latex systems to limit losses from rainfall and wind removal of inorganic actives. Actives, such as, for example, cuprous oxide, which is water insoluble, when mixed with latex (without surfactant), will persist within the latex polymer for the life of the treated foliage. The same is true for Fe, Ni, Zn, Co, Cu, Mg, and Mn. Such metals in the form of chelates or complexes that plants take up can be added to the latex and then release the metal within the plant and which otherwise plants would not take up such metals or absorb them at too high of a rate. Other metals typically do not form chelates or complexes. Other compounds for inclusion in the disclosed latex formulations, often without surfactant, include, inter alia, ammonium phosphates, urea, various boron compounds, and potassium sulfates. Thus, the disclosed latex formulations may be used for feed plants various nutrients, as described herein.

The sum of all of the data reported herein can be viewed in FIG. 14, which displays the supramolecule assemblies formed based on chemical environment, where:

| Letter | Supramolecule Assembly Formed |
|---|---|
| A | a 2-component supramolecule assembly (fungicide active/EtOH); |
| B | a 3-component supramolecule assembly (fungicide |
| | active/EtOH/surfactant) |
| C | a 4-component supramolecule assembly (fungicide |
| | active/latex/EtOH/surfactant) |
| D | a 2-component supramolecule assembly (fungicide active/ |
| | surfactant) |
| E | a 3-component supramolecule assembly (fungicide |
| | active/latex/surfactant) |
| F | a 1-component submicron particles (based on water solubility |
| | and/or non-ionic encapsulation |

Some additional observations based on the Costa Rican field trials can be made. The formulation that does not wash off the leaves prior to harvest will be returned to the soil when the leaves drop. With the disclosed latex system, perhaps between 5% and 25% of the applied fungicide active remaining on the leaves at the end of the growing season (this likely is the MeOH soluble fraction) and will be returned to the soil to be slowly released and/or degraded. This may be good, since the source of these fungal pathogens is in the soil.

Besides fungicides and insecticides, the precepts of the present disclosure permit additional actives, such as, for example, plant nutrients, with specific examples including, for example, ammonium phosphates, potassium nitrate, potassium chloride, urea, boron chemicals, and the like. Further additives include, inter alia, “agricultural biologicals” that include microbials, plant extracts, beneficial insects, and other material that farmers use to increase crop health and productivity.

While the composition, formulation, and method have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. In this application all amounts and percentages are by weight, unless otherwise expressly indicated. Also, all citations referred herein are expressly incorporated herein by reference.

1. A method for treating vegetation or soil for suppressing fungi thereon, comprising:
treating vegetation with a supramolecular assembly comprising a dilute concentrate formed from:
(a) a concentrate having components added in the following sequence fungicide, ethanol (EtOH), and a surfactant at about 1:3:1 weight ratio, respectively, and forming supramolecular assemblies comprising surfactant/fungicide/EtOH, surfactant/fungicide, and free non-associated fungicide; wherein the supramolecular assemblies form by non-covalent mechanisms being one or more of π-π interaction, hydrogen bonding, Van der Waals forces, dipole-dipole, cation-π and anion-π interaction, polar-π, hydrophobic effect, electrostatic effect, or magnetic effect; and
(b) a latex/water solution, wherein the supramolecular assemblies in the dilute concentrate now comprise latex/fungicide/surfactant, latex/fungicide, and free fungicide;
upon drying of a latex film from the dilute concentrate supramolecular assemblies, the composition of the assemblies regulates the release of fungicide from the dried latex film by the formation of active pools with varying water solubility, wherein the surfactant forms supramolecule assemblies with the fungicide via a non-covalent mechanism to produce (i) a composite surfactant/fungicide combination, a fraction of which assembles with the polymerizing latex via a non-covalent mechanism to form additional supramolecular assemblies and (ii) a fungicide/latex combination that is formed by a non-covalent mechanism;
wherein, the surfactant is one or more of polyethylene glycol, polypropylene glycol, a polylactic acid, or a polyglycolic acid, and is admixed with one or more of ethanol, methanol, or isopropanol;
wherein, the fungicide comprises an active ingredient being one or more of cyproconazole, propiconazole, chlorothalonil, tefluthrin, pyrethroids, fenpyoximate, abamectin, spiroxamine, or epoxiconazole; and
wherein the latex comprises a latex primer present in the dilute concentrate at not substantially above about 1 wt % (dry wt basis) and assists in forming the supramolecular assembly via non-covalent mechanisms being one or more of π-π interaction, hydrogen bonding, Van der Waals forces, dipole-dipole, cation-π and anion-π interaction, polar-π, hydrophobic effect, electrostatic effect, or magnetic effect.

2. The method of claim 1, wherein the latex is one or more of a primer/sealer, a polyethylene glycol oligomer, a polypropylene glycol oligomer, a butylene branched polypropylene glycol oligomer, a phenol branched polypropylene glycol oligomer, polyvinyl alcohol, polyvinyl acetate, or copolymers of polyvinyl alcohol or polyethylene glycol with acrylamides, or a styrene acrylate or methacrylate.

3. The method of claim 1, wherein the dilute concentrate is dispersed in a liquid being one or more of water, an alcohol, a paraffinic oil, a triglyceride oil, or 1,2-propanediol.

4. The method of claim 1, wherein the dilute concentrate is delivered to plants by spraying.

5. The method of claim 4, wherein the dilute concentrate is formed in the presence of static electricity and is applied to the plant in the using static electricity.

6. The method of claim 1, wherein the dilute concentrate additionally comprises an adjuvant, a sticking agent, a wetting agent, or a solvent.

7. The method of claim 1, wherein the latex additional contains an insecticide.

8. The method of claim 7, wherein said insecticide is a biocontrol agent.

9. The method of claim 1, wherein the surfactant is admixed with ethanol.

10. A composition for treating vegetation or soil for suppressing fungi thereon, comprising a dilute concentrate formed from:
(a) a concentrate having components added in the following sequence fungicide, EtOH, and surfactant, at about 1:3:1 weight ratio, respectively, and forming supramolecular assemblies comprising surfactant/fungicide/EtOH, surfactant/fungicide, and free non-associated fungicide; wherein the supramolecular assemblies form by non-covalent mechanisms being one or more of π-π interaction, hydrogen bonding, Van der Waals forces, dipole-dipole, cation-π and anion-π interaction, polar-π, hydrophobic effect, electrostatic effect, or magnetic effect; and
(b) a latex/water solution, wherein the supramolecular assemblies in the dilute concentrate now comprise latex/fungicide/surfactant, latex/fungicide, and free fungicide;
upon drying of a latex film from the dilute concentrate supramolecular assemblies, the composition of the assemblies regulates the release of fungicide from the dried latex film by the formation of active pools with varying water solubility, wherein the surfactant forms supramolecule assemblies with the fungicide via a non-covalent mechanism to produce (i) a composite surfactant/fungicide combination, a fraction of which assembles with the polymerizing latex via a non-covalent mechanism to form additional supramolecular assemblies and (ii) a fungicide/latex combination that is formed by a non-covalent mechanism;
wherein, the surfactant is one or more of polyethylene glycol, polypropylene glycol, a polylactic acid, or a polyglycolic acid, and is admixed with one or more of ethanol, methanol, or isopropanol;
wherein, the fungicide comprises an active ingredient being one or more of cyproconazole, propiconazole, chlorothalnnil, tefluthrin, pyrethroids, fenpyoximate, abamectin, spiroxamine, or epoxiconazole; and
wherein the latex comprises a latex primer present in the dilute concentrate at not substantially above about 1 wt % (dry wt basis) and assists in forming the supramolecular assembly via non-covalent mechanisms being one or more of π-π interaction, hydrogen bonding, Van der Waals forces, dipole-dipole, cation-π and anion-π interaction, polar-π, hydrophobic effect, electrostatic effect, or magnetic effect.

11. The composition of claim 10, wherein the latex is one or more of a primer/sealer, a polyethylene glycol oligomer, a polypropylene glycol oligomer, a butylene branched polypropylene glycol oligomer, a phenol branched polypropylene glycol oligomer, polyvinyl alcohol, polyvinyl acetate, or copolymers of polyvinyl alcohol or polyethylene glycol with acrylamides, or a styrene acrylate or methacrylate.

12. The composition of claim 10, wherein the latex is one or more of a primer/sealer, a polyethylene glycol oligomer, a polypropylene glycol oligomer, a butylene branched polypropylene glycol oligomer, a phenol branched polypropylene glycol oligomer, polyvinyl alcohol, polyvinyl acetate, or copolymers of polyvinyl alcohol or polyethylene glycol with acrylamides, or a styrene acrylate or methacrylate.

13. The composition of claim 10, wherein the dilute concentrate is dispersed in a liquid being one or more of water, an alcohol, a paraffinic oil, a triglyceride oil, or 1,2-propanediol.

14. The composition of claim 11, wherein the dilute concentrate is delivered to plants by spraying.

15. The composition of claim 10, wherein the dilute concentrate is formed in the presence of static electricity and is applied to the plant in the using static electricity.

16. The composition of claim 10, wherein the dilute concentrate additionally comprises an adjuvant, a sticking agent, a wetting agent, or a solvent.

17. The composition of claim 10, wherein the latex additional contains an insecticide.

18. The composition of claim 17, wherein said insecticide is a biocontrol agent.

19. The composition of claim 10, wherein the surfactant is admixed with ethanol.

20. A composition for treating vegetation or soil, comprising a dilute concentrate formed from:
(a) a concentrate having components added in the following sequence treating agent, EtOH, and surfactant, at about 1:3:1 weight ratio, respectively, and forming supramolecular assemblies comprising surfactant/treating agent/EtOH, surfactant/treating agent, and free non-associated treating agent; wherein the supramolecular assemblies form by non-covalent mechanisms being one or more of π-π interaction, hydrogen bonding, Van der Waals forces, dipole-dipole, cation-π and anion-π interaction, polar-π, hydrophobic effect, electrostatic effect, or magnetic effect; and
(b) a latex/water solution, wherein the supramolecular assemblies in the dilute concentrate now comprise latex/treating agent/surfactant, latex/treating agent, and free treating agent;
upon drying of a latex film from the dilute concentrate supramolecular assemblies, the composition of the assemblies controls treating agent active solubility and regulates the release of treating agent from the dried latex film by the formation of active pools with varying water solubility, wherein the surfactant forms supramolecule assemblies with the treating agent via a non-covalent mechanism to produce (i) a composite surfactant/treating agent combination, a fraction of which assembles with the polymerizing latex via a non-covalent mechanism to form additional supramolecular assemblies and (ii) a treating agent/latex combination that is formed by a non-covalent mechanism;
wherein, the surfactant is one or more of polyethylene glycol, polypropylene glycol, a polylactic acid, or a polyglycolic acid, and is admixed with one or more of ethanol, methanol, or isopropanol;
wherein, the treating agent comprises one or more of a fungicide, an insecticide, a plant nutrient, a microbial, or a plant extract; and
wherein the latex comprises a latex primer present in the dilute concentrate at not substantially above about 1 wt % (dry wt basis) and assists in forming the supramolecular assembly via non-covalent mechanisms being one or more of π-π interaction, hydrogen bonding, Van der Waals forces, dipole-dipole, cation-π and anion-π interaction, polar-π, hydrophobic effect, electrostatic effect, or magnetic effect.
